(19) United States
(12) Patent Application Publication
(10) Pub. No.: US 2018/0279192 A1
(43) Pub. Date: Sep. 27, 2018

(54) ENHANCED STEERING IN A NETWORK HAVING MULTIPLE ACCESS POINTS

(71) Applicant: QUALCOMM Incorporated, San Diego, CA (US)

(72) Inventors: Alireza Raissinia, Monte Sereno, CA (US); Xiaolong Huang, San Jose, CA (US); Sai Yiu Duncan Ho, San Diego, CA (US); Srinivas Katar, Fremont, CA (US); Brian Michael Buesker, San Diego, CA (US)

(21) Appl. No.: 15/927,735

(22) Filed: Mar. 21, 2018

Related U.S. Application Data
(60) Provisional application No. 62/476,254, filed on Mar. 24, 2017.

(51) Int. Cl. H04W 36/08; H04W 36/22; H04W 36/38

(52) U.S. Cl. CPC H04W 36/08; H04W 36/38; H04W 36/22

(57) ABSTRACT

This disclosure provides systems, methods and apparatus, including computer programs encoded on computer-readable media, for steering an association of a device in a network having multiple access points (APs). In one aspect, a first AP can obtain per-AP metric information regarding a plurality of other APs in the network. The per-AP metric information may include backhaul performance information regarding at least one wireless backhaul channel in the network. The per-AP metric information may include an estimated air time fraction value reported by the other APs. A selection to steer the device from the first AP to a second AP can be based, at least in part, on the per-AP metric information. In some implementations, a Multi-AP Controller can redistribute per-AP metric information collected from multiple APs in the network. In some implementations, a topology of the network may be optimized by steering a child AP to another wireless backhaul link.

### CROSS-REFERENCE TO RELATED APPLICATIONS

This Patent Application claims priority to U.S. Provisional Patent Application No. 62/476,254 filed Mar. 24, 2017, entitled “ENHANCED STEERING IN A NETWORK HAVING MULTIPLE ACCESS POINTS,” and assigned to the assignee hereof. The disclosure of the prior Application is considered part of and is incorporated by reference in this Patent Application.

### TECHNICAL FIELD

This disclosure relates to the field of network communication, and more particularly to steering a device in a network having multiple access points.

### DESCRIPTION OF THE RELATED TECHNOLOGY

Wireless communication technologies can support wireless network access for a device via an access point (AP). An AP may be communicatively coupled to a gateway (such as a cable modem, fiber optic network device, digital subscriber line (DSL) modem, or the like) to access a broadband network. The AP may provide a wireless network coverage area for one or more devices to access the broadband network via the AP. A network may include multiple APs capable of providing wireless network access. For example, a first AP can be communicatively coupled to the broadband network, and a second AP can wirelessly connect to the first AP while extending the wireless network coverage area of the network. The second AP may operate similar to the first AP by receiving, buffering, and then relaying data to and from the first AP and a device that is wirelessly associated with the second AP. It is possible to combine multiple APs such that each AP is in communication with at least one other AP to provide a larger wireless coverage area with network access to the broadband network. The wireless coverage area provided by an AP may utilize a 2.4 GHz frequency band, a 5 GHz frequency band, or both the 2.4 GHz frequency band and the 5 GHz frequency band.

When a network includes two or more APs, a device may attempt to establish a wireless association with a nearest AP. The device may select an AP and a frequency band using an AP selection algorithm at the device. For example, the device may initially associate with an AP that has the strongest signal. Once associated with a particular AP, the device may remain associated with that AP until that AP's signal strength becomes weak. As the device moves to another location, the device can disassociate from that AP, and associate with another AP that has stronger signal strength. However, the device may not be aware of the topology and network conditions when selecting which AP or frequency band to utilize for network access. Various topology and network considerations may be relevant to selecting an AP from among multiple APs in a network.

### SUMMARY

The systems, methods, and devices of this disclosure each have several innovative aspects, no single one of which is solely responsible for the desirable attributes disclosed herein.

One innovative aspect of the subject matter described in this disclosure can be implemented as by an apparatus for use in a network. The apparatus may include a processor and memory. The memory may store instructions which, when executed by the processor, cause first access point (AP) or a Multi-AP Controller of the network to perform the operations described in this disclosure. The instructions, when executed by the processor may cause a first AP to determine to steer a device that is wirelessly associated with a first fronthaul channel of the first AP to one of a plurality of other APs in the network, obtain per-AP metric information regarding one or more other APs in the network, wherein the per-AP metric information includes backhaul performance information regarding at least one wireless backhaul channel in the network, determine a target AP from the plurality of other APs based, at least in part, on per-AP metric information regarding one or more other APs in the network, and steer the device to a second fronthaul channel at the target AP.

In some implementations, the instructions to select the target AP may include instructions which, when executed by the processor, cause the first AP to determine a multi-hop topology of the network based at, least in part, on fronthaul and backhaul information regarding the plurality of other APs, and select the target AP based, at least in part, on the multi-hop topology.

In some implementations, the instructions to determine to steer the device may include instructions which, when executed by the processor, cause the first AP to perform at least one operation selected from a group consisting of: receiving a message from the Multi-AP Controller of the network, the message identifying the device, determining that a load condition of the first AP exceeds a threshold; determining to load balance the device away from the first AP based, at least in part, on fronthaul channel utilization of the first AP, determining a change in wireless resources available to the first AP, and determining a quality of service (QOS) requirement of the device.

In some implementations, the instructions to select the target AP may include instructions which, when executed by the processor, cause the first AP to determine a first backhaul performance for a first path from the first AP to a root AP of the network, and compare the first backhaul performance with a second backhaul performance for a second path from the target AP to the root AP.

In some implementations, the instructions to obtain the per-AP metric information may include instructions which, when executed by the processor, cause the first AP to send an AP Metrics Query message to at least the target AP, the AP Metrics Query message for requesting the per-AP metric information from the target AP, and receive an AP Metrics Response message from the target AP, the AP Metrics Response message including the per-AP metric information regarding the target AP.

In some implementations, the instructions to obtain the per-AP metric information may include instructions which, when executed by the processor, cause the first AP to receive a Combined Infrastructure Metrics message from a Multi-AP Controller. The Combined Infrastructure Metrics message may include the per-AP metric information regarding more than one AP in the network.

In some implementations, the per-AP metric information includes channel utilization, number of wireless clients, and an Estimated Air Time Fraction value. The Estimated Air Time Fraction value may represent a percentage of air time that a hypothetical new device joining a reporting AP would be allocated for downlink traffic from the reporting AP to the hypothetical new device.

In some implementations, the instructions, when executed by the processor, may further cause the first AP to receive an AP Metrics Query message from a Multi-AP Controller or one of the plurality of other APs, and send an AP Metrics Response message from the first AP to the Multi-AP Controller or one of the plurality of other APs, the AP Metrics Response message including per-AP metric information regarding the first AP.

In some implementations, the instructions to steer the device include instructions which, when executed by the processor, cause the first AP or the Multi-AP Controller to attempt at least one re-association activity to cause the device to re-associate to the target AP, the re-association activity selected from a group comprising at least one of: sending a Basic Service Set (BSS) Transition Management (BTM) message to the device identifying at least the target AP to cause the device to re-associate to the target AP, sending a disassociation message to the device, blocking, at the first AP, at least one incoming packet from the device, and causing another AP to attempt at least one re-association activity to cause the device to re-associate to the target AP.

Another innovative aspect of the subject matter described in this disclosure can be implemented by an apparatus for use in a network having multiple APs. The apparatus may include a processor and memory. The memory may store instructions which, when executed by the processor, cause a Multi-AP Controller of the network to perform the operations described in this disclosure. The instructions, when executed by the processor may cause a Multi-AP Controller to obtain per-AP metric information from a plurality of APs in the network, the per-AP metric information including fronthaul and backhaul performance information regarding the plurality of APs. The per-AP metric information may include backhaul performance information regarding at least one wireless backhaul channel in the network. The instructions may cause the Multi-AP Controller to determine to steer a device that is wirelessly associated with a first fronthaul channel of a first AP to a target AP from among plurality of APs based, at least in part, on the per-AP metric information. The instructions may cause the Multi-AP Controller to send an instruction message from the Multi-AP Controller to the first AP to cause the first AP to steer the device to the target AP.

In some implementations, the instruction message may identify the device and the target AP.

In some implementations, the instructions may cause the Multi-AP Controller to send an AP Metrics Query message to at least the target AP, the AP Metrics Query message for requesting the per-AP metric information from the target AP. The instructions may cause the Multi-AP Controller to receive an AP Metrics Response message from the target AP, the AP Metrics Response message including the per-AP metric information regarding the target AP.

In some implementations, the instructions may cause the Multi-AP Controller to collect per-AP metric information from multiple APs in the network. The instructions may cause the Multi-AP Controller to provide at least a portion of the collected per-AP metric information in a Combined Infrastructure Metrics message to one or more of the APs in the network.

In some implementations, the Multi-AP Controller may be collocated with one of the plurality of APs in the network.

In some implementations, the device may be a child AP that is wirelessly associated with the first AP. The first fronthaul channel of the first AP may be associated with a first backhaul channel of the child AP. The instructions may cause the Multi-AP Controller to determine to steer the child AP to a second backhaul channel that is associated with a second fronthaul channel of the target AP.

In some implementations, the instructions may cause the Multi-AP Controller to determine to steer the child AP to the second backhaul channel based, at least in part, on a multi-hop topology formed by the plurality of APs in the network.

Another innovative aspect of the subject matter described in this disclosure can be implemented as a method. The method is described as being performed by a first AP of the network. In some implementations, the method may be performed by a Multi-AP Controller of the network. The first AP may determine to steer a device that is wirelessly associated with a first fronthaul channel of the first AP to one of a plurality of other APs in the network. The first AP may obtain per-AP metric information regarding one or more other APs in the network. The per-AP metric information may include backhaul performance information regarding at least one wireless backhaul channel in the network. The first AP may select a target AP from the plurality of other APs based, at least in part, on per-AP metric information. The first AP may steer the device to a second fronthaul channel at the target AP.

In some implementations, the first AP may determine a multi-hop topology of the network based, at least in part, on fronthaul and backhaul information regarding the plurality of other APs. The first AP may select the target AP based, at least in part, on the multi-hop topology.

In some implementations, the first AP may determine to steer the device in response to receiving a message from a Multi-AP Controller of the network. The message may identify the device. The message may identify the target AP.

In some implementations, the per-AP metric information may include an Estimated Air Time Fraction value provided by the target AP.

In some implementations, the first AP may determine a first backhaul performance for a first path from the first AP to a root AP of the network. The first AP may compare the first backhaul performance with a second backhaul performance for a second path from the target AP to the root AP.

In some implementations, the first AP may send an AP Metrics Query message to at least the target AP, the AP Metrics Query message for requesting the per-AP metric information from the target AP. The first AP may receive an AP Metrics Response message from the target AP, the AP Metrics Response message including the per-AP metric information regarding the target AP.

In some implementations, the first AP may receive a Combined Infrastructure Metrics from the Multi-AP Controller. The Combined Infrastructure Metrics message may include the per-AP metric information regarding more than one AP in the network.

In some implementations, the per-AP metric information may include channel utilization, number of wireless clients, and an Estimated Air Time Fraction value. The Estimated Air Time Fraction value may represent a percentage of air time that a hypothetical new device joining a reporting AP would be allocated for downlink traffic from the reporting AP to the hypothetical new device.

In some implementations, the first AP may estimate a channel available airtime of the second AP based, at least in part, on the per-AP metric information. In some implementations, estimating the channel available airtime may include estimating a scheduling behavior associated with the second AP. In some implementations, estimating the channel available airtime may include estimating the channel available airtime based on a number of wireless clients and the scheduling behavior. In some implementations, the scheduling behavior may be one of an airtime fairness (ATF) algorithm or a weighted priority algorithm.

In some implementations, the first AP may receive an AP Metrics Query message from a Multi-AP Controller or one of the plurality of other APs. The first AP may send an AP Metrics Response message from the first AP to the Multi-AP Controller or one of the plurality of other APs. The AP Metrics Response message from the first AP may include per-AP metric information regarding the first AP.

In some implementations, steering the device may include attempting at least one re-association activity to cause the device to re-associate to the target AP. The re-association activity may include sending a Basic Service Set (BSS) Transition Management (BTM) message to the device identifying at least the target AP to cause the device to re-associate to the target AP. The re-association activity may include sending a disassociation message to the device. The re-association activity may include blocking, at the first AP, at least one incoming packet from the device. The re-association activity may include causing another AP to attempt at least one re-association activity to cause the device to re-associate to the target AP.

Another innovative aspect of the subject matter described in this disclosure can be implemented by a computer-readable medium having stored therein instructions which, when executed by a processor of a first AP for use in a network, cause the first AP to determine to steer a device that is wirelessly associated with a first fronthaul channel of the first AP to one of a plurality of other APs in the network, obtain per-AP metric information regarding one or more other APs in the network, wherein the per-AP metric information includes backhaul performance information regarding at least one wireless backhaul channel in the network, select a target AP from the plurality of other APs based, at least in part, on per-AP metric information regarding one or more other APs in the network, and steer the device to a second fronthaul channel at the target AP.

In some implementations, the instructions to select the target AP may include instructions which, when executed by the processor, cause the first AP to determine a multi-hop topology of the network based at, least in part, on fronthaul and backhaul information regarding the plurality of other APs, and select the target AP based, at least in part, on the multi-hop topology.

In some implementations, the instructions to select the target AP may include instructions which, when executed by the processor, cause the first AP to determine a first backhaul performance for a first path from the first AP to a root AP of the network, and compare the first backhaul performance with a second backhaul performance for a second path from the target AP to the root AP.

In some implementations, the instructions to obtain the per-AP metric information may include instructions which, when executed by the processor, cause the first AP to send an AP Metrics Query message to at least the target AP, the AP Metrics Query message for requesting the per-AP metric information from the target AP, and receive an AP Metrics Response message from the target AP, the AP Metrics Response message including the per-AP metric information regarding the target AP.

In some implementations, the instructions to obtain the per-AP metric information may include instructions which, when executed by the processor, cause the first AP to receive a Combined Infrastructure Metrics message from a Multi-AP Controller, the Combined Infrastructure Metrics message including the per-AP metric information regarding more than one AP in the network.

In some implementations, the per-AP metric information includes channel utilization, number of wireless clients, and an Estimated Air Time Fraction value. The Estimated Air Time Fraction value may represent a percentage of air time that a hypothetical new device joining a reporting AP would be allocated for downlink traffic from the reporting AP to the hypothetical new device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example network with multiple access points (APs).

FIG. 2 depicts system diagram of the example network with another example implementation.

FIG. 3 depicts a message flow diagram of example messages for a distributed implementation of sharing information between a first AP and a second AP for steering a device.

FIG. 4 depicts a message flow diagram of example messages for a centralized implementation of sharing information between a first AP, root AP, and a second AP for steering a device.

FIG. 5 depicts an example conceptual diagram of a message for sharing fronthaul and backhaul information.

FIG. 6 depicts a flowchart for steering a device in a network having multiple access points.

FIG. 7 depicts a flowchart for collecting fronthaul and backhaul information in a network having multiple access points.

FIG. 8 depicts a system diagram of an example network steering a child AP.

FIG. 9 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, he described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

A network in a home, apartment, business, or other area may include one or more APs that create a local area network. The local area network (LAN) (sometimes also referred to as a wireless local area network, or WLAN) may provide access to a broadband network. A gateway device, such as a central access point (CAP) or router, may provide access to the broadband network. For example, the gateway device can couple to the broadband network through a cable, a fiber optic, a powerline, or DSL network connection. Devices in the network can establish a wireless association (also referred to as a wireless link, wireless connection, or the like) with an AP to access the broadband network via the gateway device. For example, the wireless association may be in accordance with an association protocol of the AP. Typically, a device may select an AP from a plurality of APs based on signal strengths of wireless signals received from each of the plurality of APs. In addition to, or alternatively from, selecting an AP, a device also may select a frequency band. For example, the device may select between a 2.4 GHz or 5 GHz frequency band from the frequencies bands available for communication between the device and the plurality of APs. The AP, the wireless channel configuration, and the set of devices that are wirelessly associated with the AP are referred to as a Basic Service Set (BSS).

An AP may not provide uniform coverage within an environment. As the wireless signals propagate further from the AP, wireless signal strength decreases. In areas of weak signal strength, a device may not be able to establish a wireless association with the AP. In different circumstances, even if a wireless association can be established, the weak signal strength present at the device may not support high data throughput rates or may result in unsatisfactory latency or errors. Furthermore, various APs and the device may have different hardware capabilities (e.g., 2.4 GHz and/or 5 GHz support, dual band single radio, dual band dual concurrent radios (DBDC), etc.) that may affect overall performance.

A device may select a first AP and/or frequency band of the first AP based on the information available to the device. However, the first AP may have access to more information regarding link metrics (such as fronthaul and backhaul conditions) of other available APs than is available to the device. For example, a second AP may provide better wireless service for the device due to backhaul performance, loading, network topology, user movement, or other conditions. Furthermore, performance (e.g., throughput, bandwidth, latency, errors, jitter, bursting, etc.) through the network may be optimized by having the device wirelessly associated with the second AP rather than the first AP.

In accordance with this disclosure, a first AP (or a Multi-AP Controller of the network) may determine to steer the device from the first AP to the second AP of the network. A Multi-AP Controller (sometimes referred to as a root AP, or RAP) is a logical entity that implements logic for controlling the operation of a network having multiple APs. A Multi-AP controller may or may not provide a wireless coverage area itself. For brevity, some examples of this description refer to a RAP which serves as the Multi-AP Controller and also provides wireless coverage. However, in some implementations, a Multi-AP Controller may not provide wireless connectivity and may be communicatively coupled to one or more APs in the network. The Multi-AP Controller may implement protocols for communicating with one or more APs in the network to manage wireless channel selection or client steering. Steering refers to any activity which causes the device to wirelessly associate with the second AP rather than the first AP. Steering also may be referred to as a re-association activity, move, transfer, relocate, transition, switch, re-position, handover, or the like. Steering does not necessarily involve physical or geographic movement of the device. There may be many reasons to steer a device away from the first AP to a second AP, including a load condition of the first AP, load balancing, a change in wireless resources available to the first AP, and a quality of service to the device.

In one aspect of this disclosure, the selection of the second AP from among other APs in the network may be based, at least in part, on per-AP metric information (such as fronthaul and backhaul information) regarding the second AP (and/or other APs in the network). A fronthaul channel refers to a wireless capability between an AP and any device acting as a wireless client (such as a station, STA, or a child AP that is extending the wireless coverage of the AP). A child AP (also referred to as a satellite AP) may utilize a backhaul channel to access an upstream AP for connectivity to the broadband network. A backhaul channel refers to a wireless and/or wired channel between the child AP and the upstream AP. For example, the upstream AP may be a root AP or CAP that is communicatively coupled to the broadband network and provides a backhaul channel between the root AP or CAP and a child AP. In some implementations, the backhaul channel may be a wireless channel and/or may be a wireline communication channel.

For selecting which AP, or frequency band, to steer a device, a first AP (or Multi-AP Controller) may obtain per-AP metric information (such as fronthaul and backhaul information)regarding the one or more other APs in the network. Furthermore, the fronthaul and backhaul information may be used by the first AP to determine a topology of the network. For example, the first AP may identify the backhaul channels between the one or more other APs and another AP. In some implementations, the first AP and other APs may exchange the fronthaul and backhaul information (either directly or through a Multi-AP Controller). For example, the Multi-AP Controller may collect the fronthaul and backhaul information from multiple APs and redistribute at least a portion of the information to the first AP. In some implementations, the per-AP metric information may include backhaul performance information (such as capacity, latency, or throughput) regarding at least one wireless backhaul channel in the network.

The first AP (or, alternatively, the Multi-AP Controller) may select a particular BSS (associated with a target AP and wireless channel) for the device based on the per-AP metric information (fronthaul and backhaul information) about the BSSs at other APs. The first AP may steer the device to establish a wireless association with the selected BSS. There are several ways in which steering could be performed in a network. In some implementations, steering may involve the exchange of association protocol messages between the first AP and the device. The IEEE 802.11 standards may define BSS transmission management (BTM) messaging for the first AP to suggest that a device transition to a target AP. It should be noted that a steering does not necessarily involve any messages (such as a handover or handoff message) from the first AP to the device. In some implementations, the first AP and the target AP manage the wireless environment to cause the device to transition from the first AP to the target AP. For example, the first AP may send a disassociation command and/or block traffic to/from the device, causing the device to wirelessly associate with the target AP. In some implementations, the first AP may inform other APs (other than the target AP) to temporarily block association requests from the device so that the device will establish a connection with the target AP.

Particular implementations of the subject matter described in this disclosure can be implemented to realize one or more of the following potential advantages. A first AP may obtain fronthaul and backhaul information for various APs of the network. Such information may not otherwise be available for selection of an optimal wireless association of the device with one of the APs. Steering a device to wirelessly associate with a particular AP may improve service for the device or may improve operation of the network.

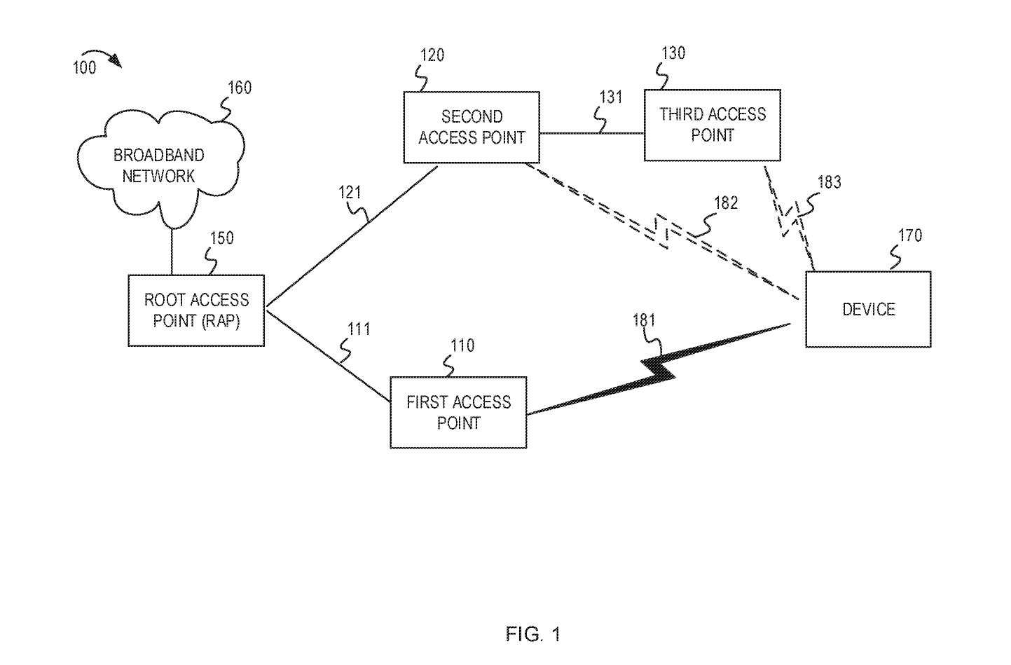

FIG. 1 depicts a system diagram of an example network with multiple access points (APs). The network 100 includes a root access point (RAP) 150 that serves as a Multi-AP Controller for the network 100. In FIG. 1, the RAP 150 also provides access to a broadband network 160. For example, the RAP 150 may be a central access point or router which is communicatively coupled to the broadband network 160. The network also includes multiple APs, including a first a first AP 110, a second AP 120, and a third AP 130. In some implementations, the RAP 150 is independent and separate from the multiple APs. In other implementations, one of the multiple APs may be collocated with the RAP 150 or may be part of the same apparatus. In this disclosure, the term AP refers to any device that provides wireless access to a network, including access points and range extenders (REs).

The first AP 110 may have a backhaul channel 111 to the RAP 150. The first AP 110 may provide several fronthaul channels, including a first fronthaul channel 181 to a device 170. The second AP 120 may have a backhaul channel 121 to the RAP 150. The second AP 120 is using one of its fronthaul channels to provide a backhaul channel 131 for the third AP 130 to communicate via the second AP 120 to the RAP 150. In this arrangement, the third AP 130 may be referred to as a child AP of the second AP 120. Similarly, the second AP 120 and first AP 110 may be referred to as child APs of the RAP 150. A child AP (also referred to as a satellite AP) is any access point that receives network access to the broadband network 160 via one or more upstream APs. For example, as shown in FIG. 1, the third AP 130 obtains access to the broadband network 160 via the second AP 120 and RAP 150. A child AP will utilize a backhaul channel to access an upstream AP. Although not shown, each of the backhaul channels 111, 121, 131 may include one or more wireless channels and/or one or more wired channels.

Each of the multiple APs may be associated with a wireless coverage area (not shown). The wireless coverage areas may overlap, and a device 170 may be within the wireless coverage area of more than one AP. The network 100 includes a device 170 (e.g., a laptop, a computer, a sensor, a camera, a thermostat, a mobile station, a wireless device, a smartphone, etc.) that is initially associated (such as a wireless association over the first fronthaul channel 181) with the first AP 110. In the example in FIG. 1, the device 170 may be a wireless station (STA). In other examples, the device 170 may be a child AP that has wireless associations with other STAs.

Although the device 170 may be initially associated with the first AP 110, the first AP 110 may not be the optimal access point to provide services to the device 170. Furthermore, the device 170 may not be aware of the topology of the network or backhaul utilization associated with one or more of the APs. Typically, the device 170 can scan the wireless channels to obtain fronthaul information about the APs within range of the device 170. Considering the scenario depicted in FIG. 1, the device 170 may be within range of the first AP 110 (via the first fronthaul channel 181) or may alternatively utilize fronthaul channels 182, 183 to the second AP 120 or the third AP 130, respectively. However, the device 170 may not know (or have access to) information about the backhaul channels 111, 121, 131. Furthermore, the device 170 may be unaware of the topology of the network in which one or more APs may be chained in various configurations to form an extended coverage area.

In this disclosure, the APs 110, 120, and 130 may assist in the identification of conditions in which the device would be better served in the network by steering the device from the first AP 110 to the second AP 120 or the third AP 130. The APs 110, 120, and 130 may exchange per-AP link metrics. The per-AP link metrics may include information about each of the BSS (including backhaul and fronthaul information) that is in operation at each AP. The per-AP link metrics may include a variety of information about each BSS at the AP. For example, the APs may exchange per-AP link metric information about channel utilization, network traffic flow, backhaul network conditions, network bandwidth availability, estimated air time (for a hypothetical new client device), estimated service parameters, or the like. The APs may exchange information regarding wireless capacity to serve the device 170 based on the capabilities of the AP or the device 170. Using the collected information, the first AP 110 may estimate the performance that would be experienced by the device 170 using either the second AP 120 or the third AP 130. Selection of the target AP to which to steer the device 170 may be based on a comparison of estimated performance for each of the APs 110, 120, and 130.

In some implementations, the estimated performance for a candidate AP may be determined based on the backhaul and fronthaul channel conditions of the candidate AP. The backhaul channel conditions may include the backhaul conditions for one or more backhaul channels used by the candidate AP to communicate with the RAP 150. For example, the backhaul channel conditions may include a consideration of multiple backhaul channels in the path to the RAP 150. The backhaul channel conditions may be based on a multi-hop path involving more than one AP that are wirelessly connected to each other (such as a chain) and to the RAP 150. The fronthaul channel conditions of the candidate AP may be based on one or more fronthaul channels of the candidate AP. For example, the estimated performance for the first AP 110 may be determined based on the backhaul channel conditions (such as via the backhaul channel 111 between the first AP 110 and the RAP 150) and the fronthaul channel conditions (such as via the fronthaul channel 181 and any other fronthaul channels of the first AP 110). The estimated performance for the second AP 120 may be determined based on the backhaul channel conditions (such as via the backhaul channel 121 between the second AP 120 and the RAP 150) and the fronthaul channel conditions (such as via the fronthaul channel 182 and any other fronthaul channels of the second AP 120). The estimated performance for the third AP 130 may be determined based on the backhaul channel conditions (such as via a combination of the backhaul channels 121 and 131 between the third AP 130 and the RAP 150) and the fronthaul channel conditions (such as via the fronthaul channel 183 and any other fronthaul channels of the third AP 130). When the combination of backhaul channel conditions and fronthaul channel conditions of the second AP 120 provides a greater estimated performance (such as a greater throughput) for the device rather than the estimated performance of the first AP 110 and the third AP 130, the first AP 110 may determine to steer the device from the first AP 110 to the second AP 120. Similarly, when the first AP 110 is overloaded (e.g., being associated with a large number of devices), the first AP 110 may determine to steer the device 170 to another one of the APs in the network 100. The first AP 110 may select the second AP 120 (or the third AP 130) based on both fronthaul and backhaul considerations.

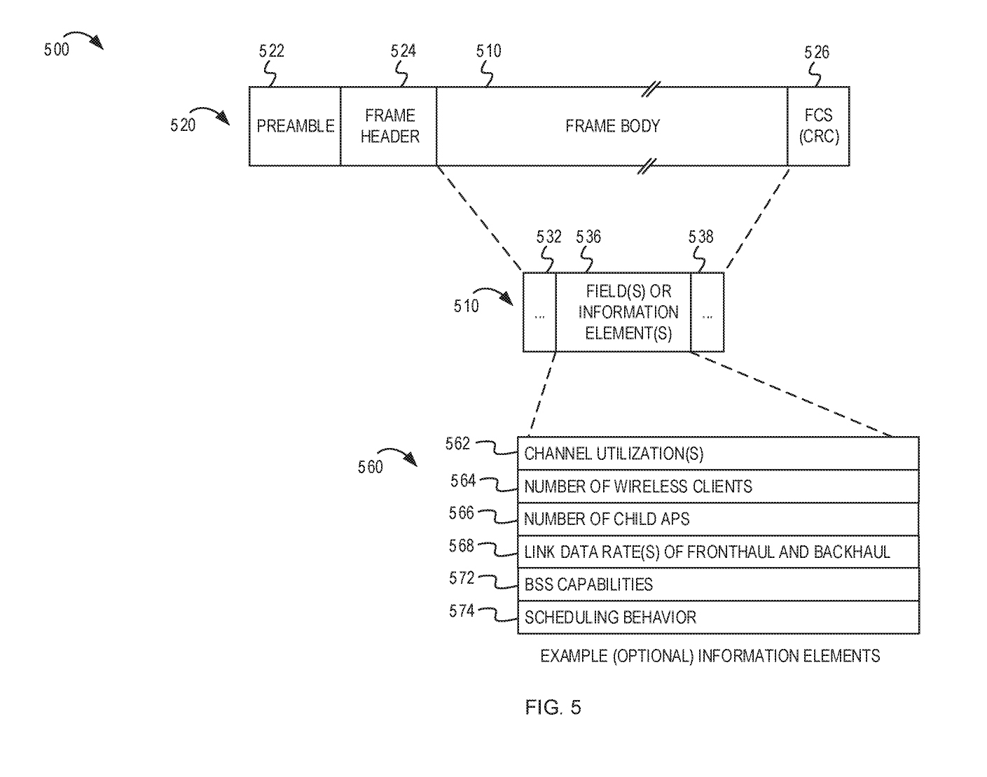

The APs 110, 120, 130 may exchange the per-AP metric information (including fronthaul or backhaul information) directly (such as using a message as described below in FIG. 5) or indirectly (by reporting the information to the RAP 150). In some implementations, the RAP 150 may collect the fronthaul and backhaul information from multiple APs and redistribute at least a portion of the information to the first AP 110. For example, if the first AP 110 has determined to steer the device 170 away (such as for load balancing reasons), the first AP 110 may request combined infrastructure metrics (which has collected fronthaul and backhaul information from multiple APs) from the RAP 150. The first AP 110 may receive the combined infrastructure metrics from the RAP 150. In other implementations, the RAP 150 may use the collected fronthaul and backhaul information to select a target AP based on the collected fronthaul and backhaul information from more than one AP. The RAP 150 may provide the first AP 110 an indication of the target AP for steering the device 170.

In the example in FIG. 1, the first AP 110 may determine to steer the device 170 to the second AP 120. The first AP 110 may determine to drop the first fronthaul channel 181 to the device 170 and cause the device 170 to establish a wireless association over a second fronthaul channel 182 to the second AP 120. For example, the second AP 120 may provide better network performance (via the second fronthaul channel 182) to the device 170 than the first AP 110 (via the first fronthaul channel 181). As an example, the second AP 120 may have less wireless utilization, a different frequency band, less backhaul latency, or the like. As another example, second AP 120 may provide a 5 GHz frequency band for communication with the device 170 which may be better suited for the type of traffic for the device 170 than a 2.4 GHz frequency band used by the first AP 110. In some implementations, the RAP 150 may manage which devices associate with the first AP 110, second AP 120, and third AP 130 based on the type of traffic used by each device. As an example, multimedia or low latency communication may be directed to the first AP 110, while best effort latency or reliable delivery communication may be directed to the second AP 120, or vice versa.

In some implementations, the first AP 110 may determine compatibility regarding wireless access technologies utilized by the device 170 and available at the multiple APs. Different wireless access technologies might be defined in standard specifications. The wireless access technologies may have different physical communication rates or protocols. The first AP 110 may utilize a first wireless access technology utilized by a first set of devices and the second AP 120 may utilize a second wireless access technology compatible with a second set of devices. If a device supports both the first wireless access technology and the second wireless access technology, a selection of the AP may be based on physical communication rates available from the wireless access technologies. The first AP 110 may determine to steer the device 170 to the second AP 120 associated with a faster effective physical communication rate than the first AP 110. The first AP 110 may command or steer the device 170 to utilize the second AP 120 rather than the first AP 110. In addition to steering the device 170 to a particular AP, the first AP 110 may select a particular frequency band (e.g., 2.4 GHz or 5 GHz) and channel, and steer the device 170 to utilize the selected frequency band and channel.

There may be various reasons for steering the device 170. For example, the device 170 may be steered to a different AP to perform load balancing on the network 100. For example, multiple devices (not shown) may communicate with the APs 110, 120, and 130. The device 170 may be transferred from the first AP 110 to the second AP 120 (or the third AP 130) based on any number of factors and conditions that may affect load balancing including, newly connected devices, intensity of communication between devices with the APs 110, 120, 130 (e.g., bandwidth, bursting, types of traffic, etc.), assigned priorities of the devices, and so forth. Another example reason to perform load balancing may be a change in quality of service (QoS) or other performance requirement of the device 170. The QoS or performance requirement of the device 170 may increase or decrease, triggering a potential reason to perform load balancing of the device 170 to another AP. Yet another example reason for load balancing is a BSS capability of the first AP 110 changes. For example, the BSS capability change may include a sudden limitation on its channel resources, space, frequency, or time). As a result of the BSS capability change, the first AP 110 may attempt to maintain a target fronthaul channel utilization by load balancing the device 170 (and/or other devices).

In one example, one or more fronthaul associations for one or more devices may be changed concurrently to improve the overall performance of the network 100. For example, the RAP 150 may have the device 170 transition from the first AP 110 to the second AP 120 to improve overall throughput through the network 100. Changes may be implemented even if the performance of the individual device 170 decreases (based on the implemented change) for the benefit of the system, network 100 or higher priority devices. Thus, the overall performance of the network 100 may be prioritized over the performance of individual devices, such as the device 170.

There are various techniques which can be used to steer the device 170 to a particular AP, frequency band, or channel. For example, steering the device 170 may include attempting at least one re-association activities steer the device 170 to the second AP 120. For example, using BTM messaging, IEEE 802.11v or other protocols, the first AP may suggest the device to re-associate to the second AP. An IEEE 802.11v configuration message may include a list of one or more other APs (for example, including the second AP 120) as a suggestion to the device to re-associate to another AP. But if the device does not support IEEE 802.11v protocols or chooses to ignore the suggestion, the first AP 110 may use another technique to steer the device 170. For example, the first AP 110 may send a disassociation message to the device 170 or the first AP 110 may block traffic (at least one incoming packet) for the device 170.

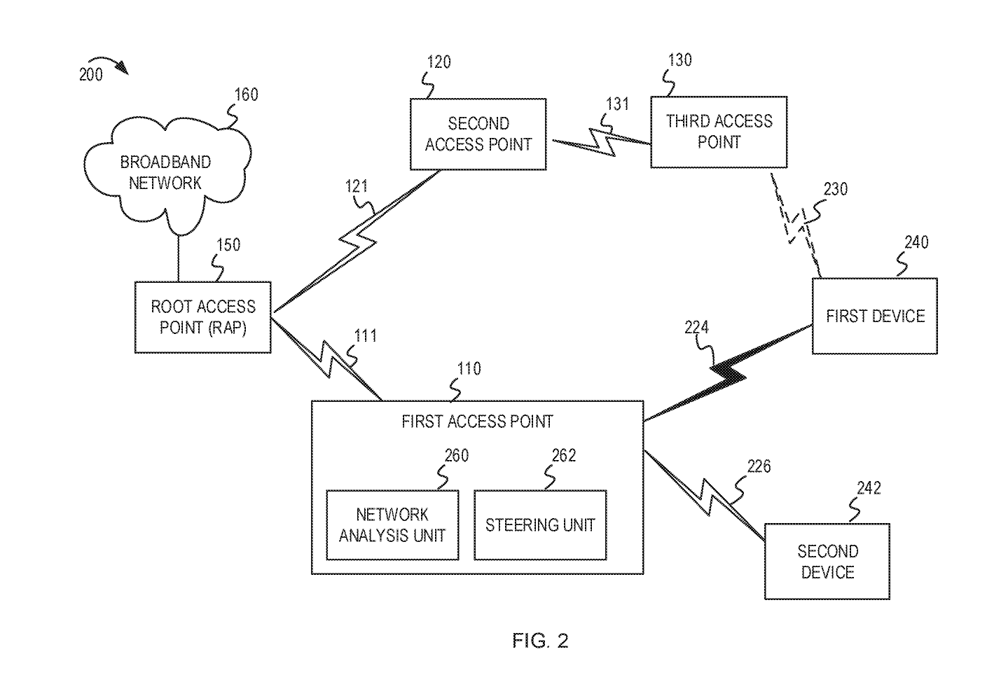

FIG. 2 depicts a system diagram of the example network shown in FIG. 1 with another example implementation. In FIG. 2, the APs 110, 120, and 130 can be used to extend the coverage of the network 200. In the example implementation of FIG. 2, the APs 110, 120, and 130 are configured as dual band, dual concurrent (DBDC) wireless device. A DBDC device can include two transceivers and can operate on two different frequency bands independently and simultaneously. For example, a first transceiver can operate in the 2.4 GHz frequency band and a second transceiver can operate in the 5 GHz frequency band. The two transceivers can be linked within the DBDC device such that data can be communicated between the transceivers. When using DBDC devices, additional network data pathway selections are possible. Furthermore, in some implementations, a network (such as a hybrid network) can support both wired and wireless communication technologies, multiple wired communication technologies, or multiple wireless communication technologies. For example, the APs 110, 120, and 130 (and/or the RAP 150) can support both IEEE 802.11 and powerline communication protocols. In other examples, the APs 110, 120, and 130 (and/or RAP 150) can support a combination of IEEE 802.11 and powerline communication protocols, a combination of IEEE 802.11 and coaxial cable (Coax) based communication protocols, a combination of long-term evolution (LTE) and IEEE 802.11 communication protocols, a combination of IEEE 802.11 and Bluetooth® communication protocols, and various other suitable combinations. Thus, the network data pathways in the hybrid network can include wired and wireless communication technologies. In other implementations, the APs 110, 120, and 130 (and/or RAP 150) can comply with other wireless specifications, such as a ZigBee® specification, or a cellular radio specification or any other technically feasible wireless protocol. The link between the RAP 150 and the broadband network 160 can be referred to as a broadband link. The broadband link can provide at least a portion of a data pathway to another network (e.g., communication service provider network, Internet, etc.). The broadband link of the RAP 150 can be a wireless, a wired (such as through an Ethernet or powerline connection), or a hybrid link.

In FIG. 2, the network 200 includes the RAP 150, the first AP 110, the second AP 120, and the third AP 130, similar to the corresponding elements described in FIG. 1. As described in FIG. 1, the RAP 150 may serve as the Multi-AP Controller of the network in this example. The network 200 also includes a first device 240 and a second device 242. In the example network 200, the RAP 150 may include routing connections or capability between the network 200 and the broadband network 160. Since the RAP 150 and the APs 110, 120, and 130 are DBDC capable, the RAP 150 and the APs 110, 120, and 130 each include two independent transceivers (not shown). The APs 110, 120, and 130 can be positioned throughout a desired coverage area of the network 200. As shown in FIG. 2, the second AP 120 is coupled to the RAP 150 through backhaul channel 121 (depicted as a wireless backhaul channel in the example network 200). Similarly, the third AP 130 is coupled to second AP 120 through backhaul channel 131 and the first AP 110 is coupled to RAP 150 through backhaul channel 111. Each link in the diagram can represent a particular frequency band (2.4 GHz or 5 GHz, for example) and a particular channel within that frequency band that can be used to carry wireless data between two devices. The frequency and channel selection can enable the RAP 150 and APs 110, 120, and 130 to communicate through links that do not interfere with other links in the network 200. For example, the RAP 150 can transmit and receive data through a first transceiver in either the 2.4 GHz band or 5 GHz band (or both) for the backhaul channel 111. The RAP 150 can transmit and receive data through a second transceiver in the 2.4 GHz band or 5 GHz band (or both) for the backhaul channel 121. In this manner, communications between the RAP 150 and the first AP 110 can have little or no effect on communications between the RAP 150 and the second AP 120.

However, the configuration flexibility of a DBDC wireless device (e.g., the RAP 150 and the APs 110, 120, and 130), can increase the complexity associated with selecting an AP, frequency band, and channel to use for wireless associations by the devices 240, 242. The first device 240 is initially coupled to the first AP 110 through fronthaul channel 224 and the second device 242 is coupled to the first AP 110 through fronthaul channel 226. As depicted, the backhaul channel 111 is the backhaul channel for the first AP 110 to access the broadband network 160 via the RAP 150. The other links (such as the fronthaul channel 224 and the fronthaul channel 226) on the AP 110 can be referred to as fronthaul channels. In a similar manner, the fronthaul channel 224 and the fronthaul channel 226 can serve other APs or stations (not shown). The backhaul channel 131 can be the backhaul channel for the third AP 130. To optimize service for the first device 240, the first AP 110 (or RAP 150) may steer the first device 240 to a different fronthaul channel at a different AP (such as fronthaul channel 230 at the third AP 130). For example, the first AP 110 may determine that the estimated performance at the third AP (based on backhaul channel conditions for backhaul channels 121, 131 and any fronthaul channels of the third AP 130) would be better than the estimated performance at either the second AP 120 or first AP 110.

In the example of FIG. 2, the first AP 110 includes a network analysis unit 260 to obtain fronthaul and backhaul information regarding the other APs in the network 200. The first AP 110 also includes a steering unit 262 to steer the first device 240 based on the information collected by the network analysis unit 260. The network analysis unit 260 can determine various channel conditions, wireless device configurations, and wireless device capabilities with respect to the components of the network 200 (such as the RAP 150, devices 240, 242 and/or APs 110, 120, and 130). For example, the network analysis unit 260 can determine a topology of the network, including backhaul channels used by other APs to communicate to the RAP 150. The first AP 110 may select a target AP (such as the third AP 130 in the example of FIG. 2) based at least in part on the channel conditions, device configurations and capabilities, and quality of service parameters for the devices 240, 242. The channel conditions can include fronthaul and backhaul information regarding the RAP 150 and the APs 110, 120, and 130. For example, the first AP 110 may compare the estimated performance via each of the APs 110, 120, and 130. The estimated performance may be based on the backhaul channel utilization and/or the available airtime estimate for each fronthaul channel available at APs 110, 120, and 130. As described above, the RAP 150, the APs 110, 120, and 130, and the devices 240, 242 can be DBDC devices capable of operating within two frequency bands. The network analysis unit 260 can determine a current configuration and capability of the DBDC devices with respect to the operating frequency bands and links. For example, the network analysis unit 260 can poll the RAP 150, the APs 110, 120, and 130, and the devices 240, 242 to determine their respective configurations and capabilities. The network analysis unit 260 also can determine the configuration and capabilities of non-DBDC devices.

The steering unit 262 may consider the fronthaul and backhaul information obtained by the network analysis unit 260 when selecting an appropriate target AP. For example, the steering unit 262 may determine that the backhaul channel 111 is congested and initiate operations to steer the first device 240 (and/or the second device 242) to the target AP due to the congestion on backhaul channel 111. In some implementations, the steering unit 262 may consider the potential impact and/or service that would be expected after steering. For example, the steering unit 262 may estimate the channel utilization (percentage of channel busy and idle time) for the fronthaul and backhaul channels of one or more candidate APs (such as APs 120 and 130). The steering unit 262 may estimate a channel available airtime at a candidate AP. For example, the steering unit 262 may consider a scheduling behavior of the candidate AP. Examples of scheduling behavior may include Airtime Fairness (ATF) or weighted priority scheduling. In some implementations, the network analysis unit 260 may determine the scheduling behavior of a candidate AP from the received fronthaul and backhaul information. In other implementations, the network analysis unit 260 may determine the scheduling behavior by observing the wireless channel utilization of a nearby AP. In yet other implementations, the network analysis unit 260 may determine the scheduling behavior by obtaining configuration parameters for the candidate AP (either directly from the candidate AP, or indirectly from a RAP). Using the scheduling behavior and the number of devices (both client STAs and child APs) that are wirelessly associated with the candidate AP, the steering unit 262 may estimate the channel available airtime for a fronthaul channel of the candidate AP. In some implementations, the channel available airtime may be considered when selecting a target AP for steering the first device 240 (and/or the second device 242).

In some implementations the APs in the network may communicate the estimated channel available airtime (which may be referred to as the Estimated Air Time Fraction). The Estimated Air Time Fraction represents the predicted percentage of air time that a hypothetical new device joining a BSS (at an AP) would be allocated for downlink traffic to the hypothetical new device. Each AP may independently calculate the Estimated Air Time Fraction and communicate the Estimated Air Time Fraction to another AP (or the Multi-AP Controller). For example, the network analysis unit 260 of the first AP 110 may receive Estimated Air Time Fraction information that has been determined by each of the second AP 120 and the third AP 130. The steering unit 262 may use the Estimated Air Time Fraction information to select a target AP that provides the greatest Estimated Air Time Fraction as reported by each of the other APs.

In the example in FIG. 2, the backhaul channel 121 and backhaul channel 131 has more available capacity (than the backhaul channel 111) and third AP 130 is selected as the target AP for handling a wireless association from the first device 240. The steering unit 262 also may select a target frequency band and channel for the first device 240 to use when re-associating with the third AP 130. After selecting the third AP 130, the steering unit 262 may steer the first device 240 to the third AP 130. As described above, steering may include sending a message to the first device 240 (or other re-association technique) to cause the first device 240 to re-associate with the third AP 130.

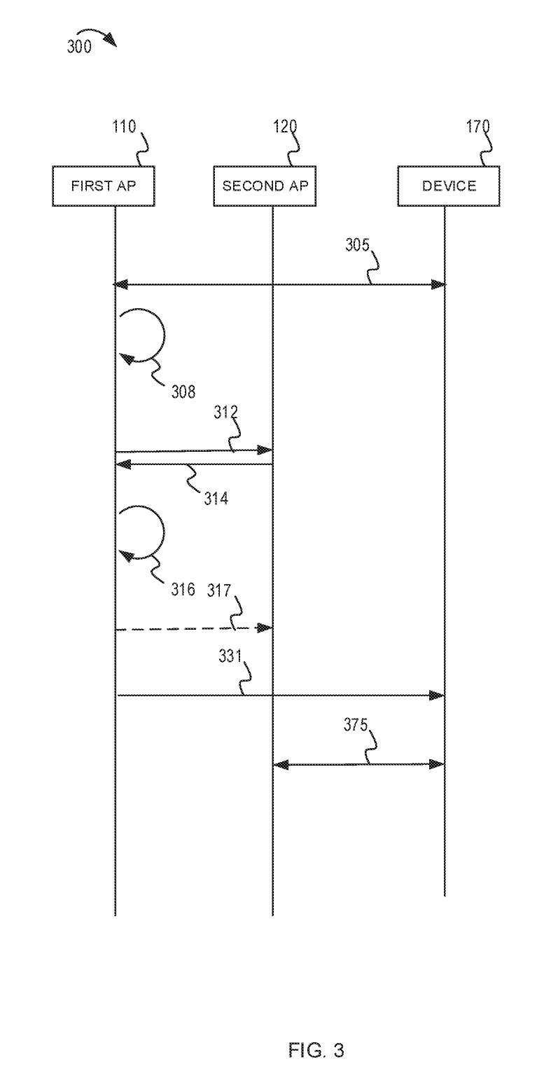

FIG. 3 depicts a message flow diagram of example messages for a distributed implementation of sharing information between a first AP and a second AP for steering a device. The diagram 300 describes example messages exchanged between a device 170, a first AP 110, and a second AP 120 to steer the device 170 from the first AP 110 to the second AP 120 in a network. Prior to steering the device 170, the device 170 has a wireless association (shown at arrow 305) with the first AP 110. The first AP 110 may determine (at 308) to steer the device 170 away from the first AP 110. For example, the first AP 110 may determine that its fronthaul channels are saturated or congested and begins a load balancing action to steer away one or more devices.

Before steering the device 170, the first AP 110 will obtain fronthaul and backhaul information regarding one or more other APs in the network. For example, the first AP 110 may send an AP Metrics Query message (shown as arrow 312) to request the per-AP metric information (such as the fronthaul and backhaul information) from the second AP 120. The first AP 110 may receive an AP Metrics Response message (shown as arrow 314) from the second AP 120. The response may include more information than would normally be available to the device 170. For example, the fronthaul and backhaul information may include channel utilization, capacity, estimated air time fraction, or latency regarding a backhaul channel used by the second AP 120. In some implementations, the first AP 110 may send other AP Metrics Query messages (not shown) to request fronthaul and backhaul information from one or more other APs in the network, such as the third AP 130 shown in FIG. 1. It is noted that although this example describes requesting (or soliciting) the per-AP metric information (fronthaul and backhaul information) from one or more other APs in the network, in some implementations each of the APs may periodically send (or broadcast) unsolicited messages to the network to report their fronthaul and backhaul information.

At 316, based at least in part on the response 314 from the second AP 120, the first AP 110 may determine to steer the device 170 to the second AP 120. For example, the first AP 110 may compare the fronthaul and backhaul performance information for the second AP 120 and the other APs (such as the third AP), and select the second AP 120 based on the comparison. In some implementations, the first AP 110 may send a message (shown at dashed arrow 317) to the second AP 120 to inform the second AP 120 that the device 170 is being steered to the second AP 120.

At 331, the first AP 110 steers the device 170 to the second AP 120. For example, the first AP 110 may send a message instructing (or requesting) the device 170 to establish a wireless association with the second AP 120. At 375, the device 170 may establish a new wireless association with the second AP 120.

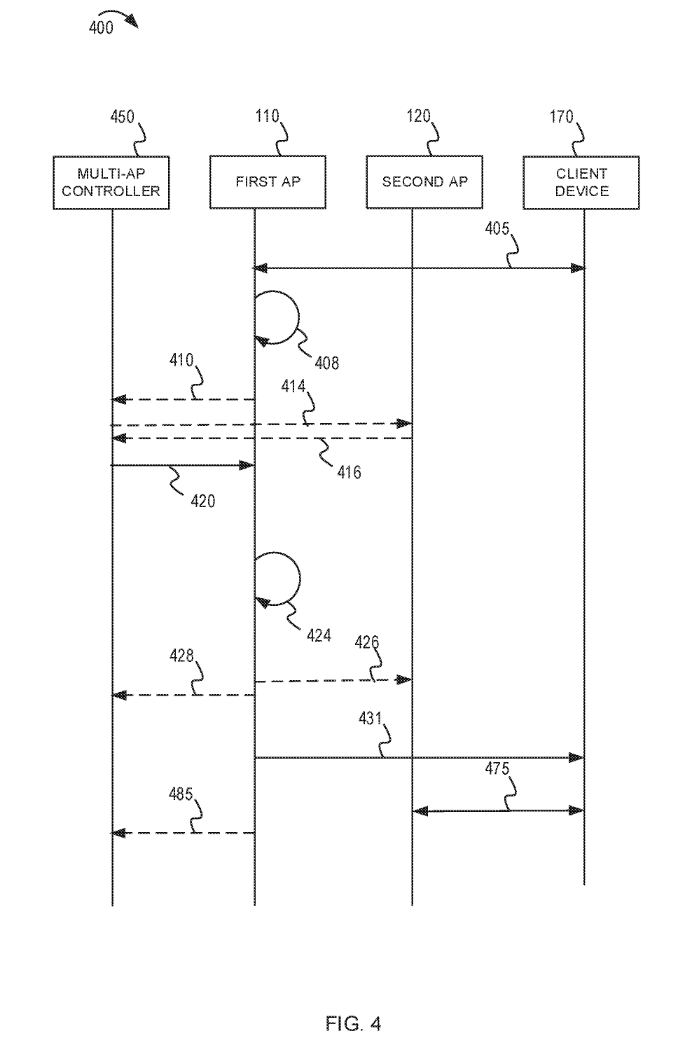

FIG. 4 depicts a message flow diagram of example messages for a centralized implementation of sharing information between a first AP, Multi-AP Controller, and a second AP for steering a device. The diagram 400 describes example messages exchanged between a first AP 110, a Multi-AP Controller 450, and a second AP 120 to steer a device 170 from the first AP 110 to the second AP 120 in a network. In some implementations, the Multi-AP Controller may be implemented in an AP similar to the RAP 150 described elsewhere in this disclosure. Prior to steering the device 170, the device 170 has a wireless association (shown at arrow 405) with the first AP 110. The first AP 110 may determine (at 408) to steer the device 170 away from the first AP 110 (such as for any of the reasons described in this document).

Before steering the device 170, the first AP 110 will obtain fronthaul and backhaul information regarding one or more other APs in the network. In FIG. 4, the first AP 110 may obtain a least a portion of the fronthaul and backhaul information collected by the Multi-AP Controller 450. The first AP 110 may send a request message (shown as arrow 410) to request the fronthaul and backhaul information from the Multi-AP Controller 450. The first AP 110 may receive a Combined Infrastructure Metrics message (shown as arrow 420) from the Multi-AP Controller 450. The Combined Infrastructure Metrics message may include collected per-AP metric information from more than one AP in the network.

If the Multi-AP Controller 450 does not already have the information collected, the Multi-AP Controller 450 may request the information from one or more of the APs in the network. For example, the Multi-AP Controller 450 may send an AP Metrics Query message (shown as arrow 414) to request the fronthaul and backhaul information from the second AP 120. The Multi-AP Controller 450 may receive an AP Metrics Response message (shown as arrow 416) from the second AP 120. In some implementations, the Multi-AP Controller 450 already has the fronthaul and backhaul information collected prior to receiving the message 410 from the first AP 110. For example, each AP in the network may be configured to periodically report the fronthaul and backhaul information to the Multi-AP Controller 450. Alternatively, the Multi-AP Controller 450 may periodically poll the APs to collect the fronthaul and backhaul information. In some implementations, the Multi-AP Controller 450 may send the Combined Infrastructure Metrics message 420 or an instruction message (not shown) to the first AP 110 without having first received a request 410 from the first AP 110.

At 424, based at least in part on the Combined Infrastructure Metrics message 420 or an instruction message (not shown)from the Multi-AP Controller 450, the first AP 110 may determine to steer the device 170 to the second AP 120. For example, the first AP 110 may compare the fronthaul and backhaul performance information for the second AP 120 and the other APs (such as the third AP), and select the second AP 120 based on the comparison. Alternatively, the Multi-AP Controller 450 may compare the fronthaul and backhaul performance information and make a selection of the second AP 120. If the Multi-AP Controller 450 makes the selection, the Multi-AP Controller 450 may inform the first AP 110 of the selection. In some implementations, the first AP 110 may send a Client Association Control Request message (shown at dashed arrow 426) to the second AP 120 to inform the second AP 120 that the device 170 is being steered to the second AP 120. Additionally, in some implementations, the first AP 110 may send a message (shown at dashed arrow 428) to the Multi-AP Controller 450 to inform the Multi-AP Controller 450 that the device 170 is being steered to the second AP 120.

At 431, the first AP 110 steers the device 170 to the second AP 120. For example, the first AP 110 may send a message instructing (or requesting) the device 170 to establish a wireless association with the second AP 120. At 475, the device 170 may establish a new wireless association with the second AP 120. After the device 170 has been steered to the second AP 120, the first AP 110 may send a Steering Completed message 485 to the Multi-AP Controller 450.

FIG. 5 depicts an example conceptual diagram of a message for sharing fronthaul and backhaul information. For example, the message may be sent from one AP (including the root AP or Multi-AP Controller) to another AP. In some implementations, the message may be a type-length-value (TLV) formatted message. FIG. 5 includes an example data frame 520. The data frame 520 may include a preamble 522, a frame header 524, a frame body 510, and a frame check sequence (FCS) 526. The preamble 522 may include one or more bits to establish synchronization. The frame header 524 may include source and destination network addresses (such as the network address of the sending AP and receiving AP, respectively), the length of data frame, or other frame control information. The frame body 510 may be organized with a message format and may include a variety of fields or information elements 532, 536, and 538.

Various fields or information elements may be used to share fronthaul and backhaul information regarding a described AP. Several examples of information elements 560 are illustrated in FIG. 5. For example, the information elements may include channel utilization 562 for one or more channels being used by the described AP. The information elements may include the number of wireless clients 564, number of child APs 566, link data rate(s) of fronthaul and backhaul channels being used by the described AP, BSS capabilities 572, or scheduling behavior 574 regarding the described AP. The information elements may include an Estimated Air Time Fraction, or other information describing estimated performance that an AP may expect to provide to a new client device.

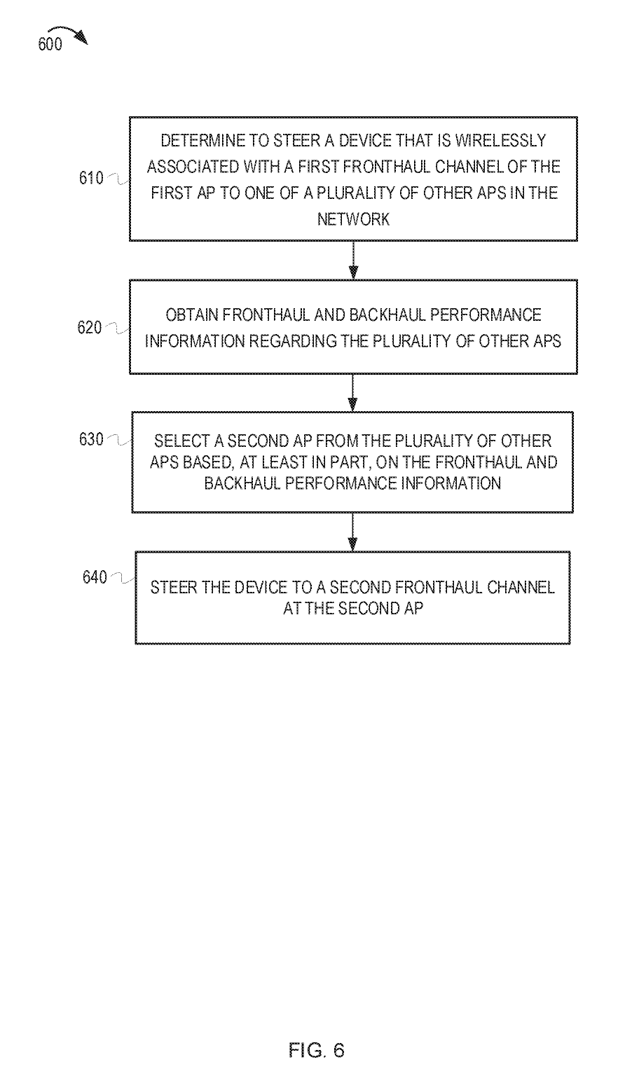

FIG. 6 depicts a flowchart for steering a device in a network having multiple access points. The flowchart 600 begins at block 610. At block 610, a first AP may determine to steer a device that is wirelessly associated with a first fronthaul channel of the first AP to one of a plurality of other APs in the network. At block 620, the first AP may obtain fronthaul and backhaul performance information regarding the plurality of other APs. At block 630, the first AP may select a second AP from the plurality of other APs based, at least in part, on the fronthaul and backhaul performance information. At block 640, the first AP may steer the device to a second fronthaul channel at the second AP.

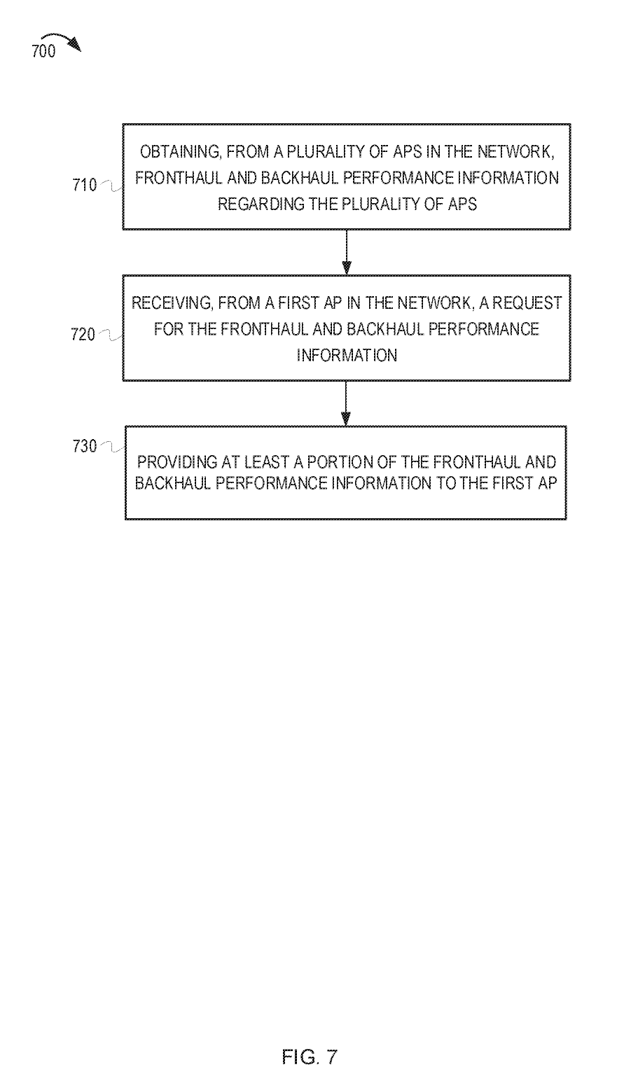

FIG. 7 depicts a flowchart for collecting fronthaul and backhaul information in a network having multiple access points. The flowchart 700 begins at block 710. At block 710, a Multi-AP Controller may obtain, from a plurality of APs in the network, fronthaul and backhaul performance information regarding the plurality of APs. At block 720, the Multi-AP Controller may receive, from a first AP in the network, a request for the fronthaul and backhaul performance information. At block 730, a Multi-AP Controller may provide at least a portion of the fronthaul and backhaul performance information to the first AP. The first AP may use the fronthaul and backhaul performance information to make a steering decision. Alternatively, after the Multi-AP Controller receives the fronthaul and backhaul information from the plurality of APs, the Multi-AP Controller may select a target AP for the first AP to use for steering.

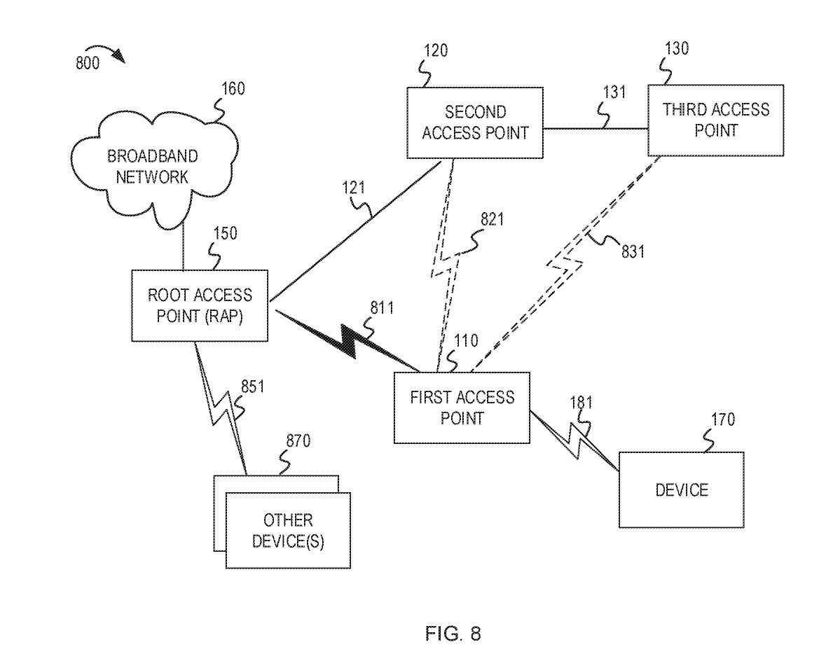

FIG. 8 depicts a system diagram of an example network steering a child AP. In FIG. 8, a network 800 includes a RAP 150 communicatively coupled to a broadband network 160. The network 800 includes the first AP 110, the second AP 120, and the third AP 130 as described in FIG. 1. The second AP 120 is coupled by backhaul channel 121 to the RAP 150. The third AP 130 is coupled by backhaul channel 131 to the second AP 120. The backhaul channel 121 and backhaul channel 131 may be wired or wireless backhaul channels. The first AP 110 is coupled by a wireless backhaul channel 811. For example, the wireless backhaul channel 811 may be wirelessly associated to a fronthaul channel of the RAP 150. The first AP 110 also has a wireless association via a first fronthaul channel 181 to the device 170.

Also, shown in FIG. 8, the RAP 150 also may have other devices 870 that are utilizing fronthaul channels 850 of the RAP 150. It is worth mentioning that while the Figures in this document may not depict other devices having wireless associations with the various APs, it is assumed that each AP may have zero, one, or more devices with wireless associations (via fronthaul channels, such as serving links) to them. For brevity, FIG. 8 only depicts the device 170 and the other devices 870.

In an example scenario, the RAP 150 may determine that load balancing one or more of the devices on its fronthaul channels would improve network capacity. For example, the fronthaul channels of the RAP 150 may be saturated or congested. One possibility, depicted in FIG. 8, is that the RAP 150 may steer the first AP 110 to utilize a different backhaul channel via one of the other APs (such as the second AP 120 or the third AP 130). The RAP 150 may obtain fronthaul and backhaul information regarding each of the APs in the network and determine that steering the first AP 110 would optimize the network. For example, the backhaul channel 121 may be lightly loaded and steering the first AP 110 to the second AP 120 may free up some of the fronthaul channel bandwidth available at the RAP 150 to service the other devices 870. The RAP 150 may estimate the impact of steering the first AP 110 to either the second AP 120 or the third AP 130, and make a comparison based on the estimated impacts. In the example scenario in FIG. 8, the first AP 110 may be steered to utilize a new backhaul channel 821 to the second AP 120 or a new backhaul channel 831 to the third AP 130. In some implementations, steering the first AP 110 to the second AP 120 or third AP 130 may not adversely impact the service to the device 170, while positively impacting the service to the other devices 870.

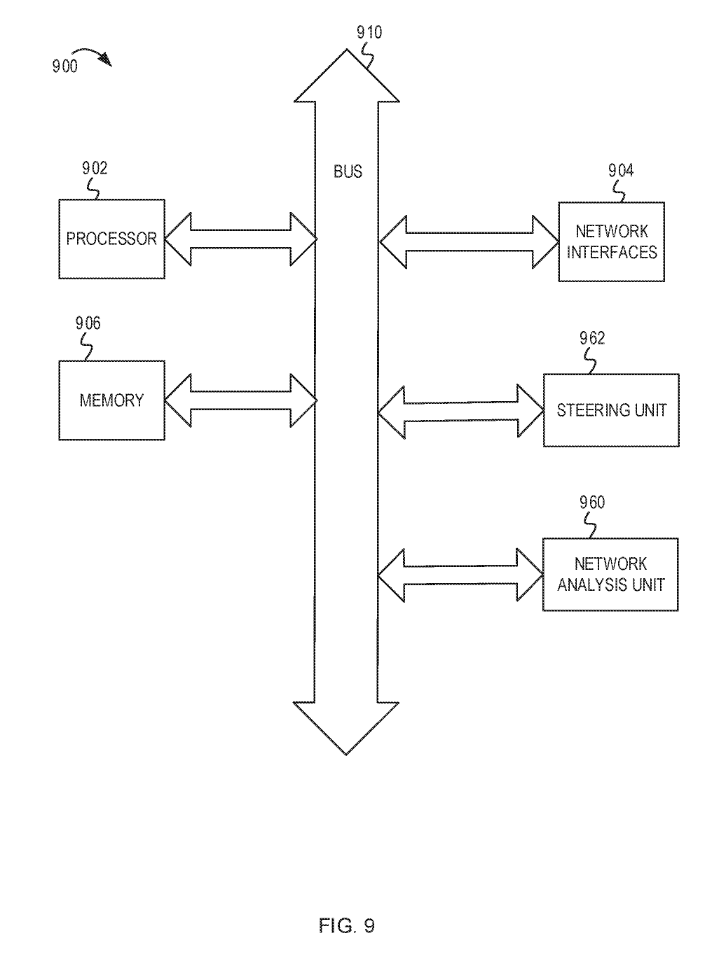

FIG. 9 shows a block diagram of an example electronic device for implementing aspects of this disclosure. In some implementations, the electronic device 900 may be one of an access point (including any of the APs described herein), a range extender, or other electronic systems. The electronic device 900 can include a processor unit 902 (possibly including multiple processors, multiple cores, multiple nodes, and/or implementing multi-threading, etc.). The electronic device 900 also can include a memory unit 906. The memory unit 906 may be system memory or any one or more of the below described possible realizations of computer-readable media. The electronic device 900 also can include a bus 910 (e.g., PCI, ISA, PCI-Express, HyperTransport®, InfiniBand®, NuBus, AHB, AXI, etc.), and a network interface 904 that can include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 900 may support multiple network interfaces—each of which is configured to couple the electronic device 900 to a different communication network.

The network interface 904 may include wireless transceivers such as a first transceiver and a second transceiver described in FIG. 2 above. The electronic device 900 may include a network analysis unit 960 (similar to the network analysis unit 260 described in FIG. 2) and a steering unit 962 (similar to the steering unit 262 described in FIG. 2). In some implementations, the network analysis unit 960 and steering unit 962, can be distributed within the processor unit 902, the memory unit 906, and the bus 910. The network analysis unit 960 and steering unit 962 can perform some or all of the operations described in FIGS. 1-8 above. The network analysis unit 960 can determine fronthaul and backhaul information regarding other APs in the network. The steering unit 962 can select a target AP from among the APs in the network using the fronthaul and backhaul information obtained by the network analysis unit 960. The steering unit 962 can steer a device (such as a client STA or child AP) to the target AP.

The memory unit 906 can include computer instructions executable by the processor unit 902 to implement the functionality of the implementations described in FIGS. 1-8 above. Any one of these functionalities may be partially (or entirely) implemented in hardware and/or on the processor unit 902. For example, the functionality may be implemented with an application specific integrated circuit, in logic implemented in the processor unit 902, in a co-processor on a peripheral device or card, etc. Further, realizations may include fewer or additional components not illustrated in FIG. 9 (e.g., video cards, audio cards, additional network interfaces, peripheral devices, etc.). The processor unit 902, the memory unit 906, the network interface 904, and the network configurator unit 908 are coupled to the bus 910. Although illustrated as being coupled to the bus 910, the memory unit 906 may be coupled to the processor unit 902.

FIGS. 1-9 and the operations described herein are examples meant to aid in understanding example implementations and should not be used to limit the potential implementations or limit scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for use in a network, comprising:
a processor; and
memory having instructions stored therein which, when executed by the processor cause a first access point (AP) or a Multi-AP Controller of the network to:
determine to steer a device that is wirelessly associated with a first fronthaul channel of the first AP to one of a plurality of other APs in the network;
obtain per-AP metric information regarding one or more other APs in the network, wherein the per-AP metric information includes backhaul performance information regarding at least one wireless backhaul channel in the network;
select a target AP from the plurality of other APs based, at least in part, on the per-AP metric information; and
steer the device to a second fronthaul channel at the target AP.

2. The apparatus of claim 1, wherein the instructions to select the target AP include instructions which, when executed by the processor, cause the first AP or the Multi-AP Controller to:
determine a multi-hop topology of the network based at, least in part, on fronthaul and backhaul information regarding the plurality of other APs; and
select the target AP based, at least in part, on the multi-hop topology.

3. The apparatus of claim 1, wherein the instructions to determine to steer the device include instructions which, when executed by the processor, cause the first AP to perform at least one operation selected from the group consisting of:
receiving a message from the Multi-AP Controller of the network, the message identifying the device;
determining that a load condition of the first AP exceeds a threshold;
determining to load balance the device away from the first AP based, at least in part, on fronthaul channel utilization of the first AP;
determining a change in wireless resources available to the first AP; and
determining a quality of service (QOS) requirement of the device.

4. The apparatus of claim 1, wherein the per-AP metric information includes an Estimated Air Time Fraction value provided by the target AP.

5. The apparatus of claim 1, wherein the instructions to select the target AP include instructions which, when executed by the processor, cause the first AP or the Multi-AP Controller to:
determine a first backhaul performance for a first path from the first AP to a root AP of the network; and
compare the first backhaul performance with a second backhaul performance for a second path from the target AP to the root AP.

6. The apparatus of claim 1, wherein the instructions to obtain the per-AP metric information include instructions which, when executed by the processor, cause the first AP or the Multi-AP Controller to:
send an AP Metrics Query message to at least the target AP, the AP Metrics Query message for requesting the per-AP metric information from the target AP; and
receive an AP Metrics Response message from the target AP, the AP Metrics Response message including the per-AP metric information regarding the target AP.

7. The apparatus of claim 1 wherein the instructions to obtain the per-AP metric information include instructions which, when executed by the processor, cause the first AP to:
receive a Combined Infrastructure Metrics message from the Multi-AP Controller, the Combined Infrastructure Metrics message including the per-AP metric information regarding more than one AP in the network.

8. The apparatus of claim 1,
wherein the per-AP metric information includes channel utilization, number of wireless clients, and an Estimated Air Time Fraction value, and
wherein the Estimated Air Time Fraction value represents a percentage of air time that a hypothetical new device joining a reporting AP would be allocated for downlink traffic from the reporting AP to the hypothetical new device.

9. The apparatus of claim 1, wherein instructions, when executed by the processor, further cause the first AP to:
receive an AP Metrics Query message from the Multi-AP Controller or one of the plurality of other APs; and
send an AP Metrics Response message from the first AP to the Multi-AP Controller or one of the plurality of other APs, the AP Metrics Response message including the per-AP metric information regarding the first AP.

10. The apparatus of claim 1, wherein instructions, when executed by the processor, further cause the first AP to:
receive an AP Metrics Query message from the Multi-AP Controller or one of the plurality of other APs; and
send an AP Metrics Response message from the first AP to the Multi-AP Controller or one of the plurality of other APs, the AP Metrics Response message including the per-AP metric information regarding the first AP.

11. The apparatus of claim 1, wherein the instructions to steer the device include instructions which, when executed by the processor, cause the first AP or the Multi-AP Controller to attempt at least one re-association activity to cause the device to re-associate to the target AP, the re-association activity selected from a group comprising at least one of:
sending a Basic Service Set (BSS) Transition Management (BTM) message to the device identifying at least the target AP to cause the device to re-associate to the target AP;
sending a disassociation message to the device;
blocking, at the first AP, at least one incoming packet from the device; and
causing another AP to attempt at least one re-association activity to cause the device to re-associate to the target AP.

12. An apparatus for use in a network having multiple access points (APs), the apparatus comprising:
a processor; and
memory having instructions stored therein which, when executed by the processor cause a Multi-AP Controller of the network to:
obtain per-AP metric information from a plurality of APs in the network, the per-AP metric information including fronthaul and backhaul performance information regarding the plurality of APs, wherein the per-AP metric information includes backhaul performance information regarding at least one wireless backhaul channel in the network;
determine to steer a device that is wirelessly associated with a first fronthaul channel of a first AP to a target AP from among the plurality of APs based, at least in part, on the per-AP metric information; and
send an instruction message from the Multi-AP Controller to the first AP to cause the first AP to steer the device to the target AP.

13. The apparatus of claim 12, wherein the instruction message identifies the device and the target AP.

14. The apparatus of claim 12, wherein the instructions to obtain the per-AP metric information include instructions which, when executed by the processor, cause the Multi-AP Controller to:
send an AP Metrics Query message to at least the target AP, the AP Metrics Query message for requesting the per-AP metric information from the target AP; and
receive an AP Metrics Response message from the target AP, the AP Metrics Response message including the per-AP metric information regarding the target AP.

15. The apparatus of claim 12, wherein the instructions, when executed by the processor, further cause the Multi-AP Controller to:
collect the per-AP metric information from multiple APs in the network; and
provide at least a portion of the collected per-AP metric information in a Combined Infrastructure Metrics message to one or more of the APs in the network.

16. The apparatus of claim 12, wherein the Multi-AP Controller is collocated with one of the plurality of APs in the network.

17. The apparatus of claim 12,
wherein the device comprises a child AP that is wirelessly associated with the first AP, the first fronthaul channel of the first AP is associated with a first backhaul channel of the child AP, and
wherein the instructions to determine to steer the device include instructions which, when executed by the processor, cause the Multi-AP Controller to determine to steer the child AP to a second backhaul channel that is associated with a second fronthaul channel of the target AP.

18. The apparatus of claim 17,
wherein the instructions to determine to steer the child AP to the second backhaul channel is based, at least in part, on a multi-hop topology formed by the plurality of APs in the network.

19. A method performed by a first access point (AP) or a Multi-AP Controller of a network, the method comprising:
determining to steer a device that is wirelessly associated with a first fronthaul channel of the first AP to one of a plurality of other APs in the network;
obtaining per-AP metric information regarding one or more other APs in the network, wherein the per-AP metric information includes backhaul performance information regarding at least one wireless backhaul channel in the network;
selecting a target AP from the plurality of other APs based, at least in part, on the per-AP metric information; and
steering the device to a second fronthaul channel at the target AP.

20. The method of claim 19, wherein selecting the target AP includes:
determining a multi-hop topology of the network based at, least in part, on fronthaul and backhaul information regarding the plurality of other APs; and
selecting the target AP based, at least in part, on the multi-hop topology.

21. The method of claim 19, wherein selecting the target AP includes:
determining a first backhaul performance for a first path from the first AP to a root AP of the network; and
comparing the first backhaul performance with a second backhaul performance for a second path from the target AP to the root AP.

22. The method of claim 19, wherein obtaining the per-AP metric information includes:
sending an AP Metrics Query message to at least the target AP, the AP Metrics Query message for requesting the per-AP metric information from the target AP; and
receiving an AP Metrics Response message from the target AP, the AP Metrics Response message including the per-AP metric information regarding the target AP.

23. The method of claim 19, wherein obtaining the per-AP metric information includes:
receiving a Combined Infrastructure Metrics message from the Multi-AP Controller, the Combined Infrastructure Metrics message including the per-AP metric information regarding more than one AP in the network.

24. The method of claim 19,
wherein the per-AP metric information includes channel utilization, number of wireless clients, and an Estimated Air Time Fraction value, and
wherein the Estimated Air Time Fraction value represents a percentage of air time that a hypothetical new device joining a reporting AP would be allocated for downlink traffic from the reporting AP to the hypothetical new device.

25. A computer-readable medium having stored therein instructions which, when executed by a processor of an apparatus in a network, cause the apparatus to:
determine to steer a device that is wirelessly associated with a first fronthaul channel of a first AP to one of a plurality of other APs in the network;
obtain per-AP metric information regarding one or more other APs in the network, wherein the per-AP metric information includes backhaul performance information regarding at least one wireless backhaul channel in the network;
select a target AP from the plurality of other APs based, at least in part, on the per-AP metric information regarding one or more other APs in the network; and
steer the device to a second fronthaul channel at the target AP.

26. The computer-readable medium of claim 25, wherein the instructions to determine the target AP include instructions which, when executed by the processor, cause the apparatus to:
determine a multi-hop topology of the network based at, least in part, on fronthaul and backhaul information regarding the plurality of other APs; and
select the target AP based, at least in part, on the multi-hop topology.

27. The computer-readable medium of claim 25, wherein the instructions to select the target AP include instructions which, when executed by the processor, cause the apparatus to:
determine a first backhaul performance for a first path from the first AP to a root AP of the network; and
compare the first backhaul performance with a second backhaul performance for a second path from the target AP to the root AP.

28. The computer-readable medium of claim 25, wherein the instructions to obtain the per-AP metric information include instructions which, when executed by the processor, cause the apparatus to:
send an AP Metrics Query message to at least the target AP, the AP Metrics Query message for requesting the per-AP metric information from the target AP; and
receive an AP Metrics Response message from the target AP, the AP Metrics Response message including the per-AP metric information regarding the target AP.

29. The computer-readable medium of claim 25, wherein the instructions to obtain the per-AP metric information include instructions which, when executed by the processor, cause the apparatus to:
receive a Combined Infrastructure Metrics message from a Multi-AP Controller, the Combined Infrastructure Metrics message including the per-AP metric information regarding more than one AP in the network.

30. The computer-readable medium of claim 25,
wherein the per-AP metric information includes channel utilization, number of wireless clients, and an Estimated Air Time Fraction value, and
wherein the Estimated Air Time Fraction value represents a percentage of air time that a hypothetical new device joining a reporting AP would be allocated for downlink traffic from the reporting AP to the hypothetical new device.
